(19) United States
(12) Patent Application Publication
(10) Pub. No.: US 2022/0168775 A1
(43) Pub. Date: Jun. 2, 2022

(54) JOINT FILLER SYSTEM AND METHODS OF USE THEREOF

(71) Applicant: VeloBond, Inc., Upland, CA (US)

(72) Inventors: Doug W. SWANSON, Upland, CA (US); Eddie J. Ruiz, Upland, CA (US)

(21) Appl. No.: 17/107,239

(22) Filed: Nov. 30, 2020

(51) Int. Cl. B05C 17/005

(52) U.S. Cl. CPC B05C 17/00556; B05C 17/00566; B05C 17/00569

(57) ABSTRACT

Described is a joint filler apparatus for transporting, mixing, and selectively dispensing a two-part joint filler material. The apparatus includes a first suction tube configured to have a distal end thereof submerged in the first material and a first pump configured to provide a suction force to the first suction tube for conveying the first material to a joint filler wand. The apparatus further includes a second suction tube configured to have a distal end thereof submerged within the second material, and a second pump configured to provide a suction force to the second suction tube for conveying the second material from the second container to the joint filler wand. The first pump and second pump are fluidly connected to the joint filler wand via a hose and the first material and the second are conveyed to a distal end of the joint filler wand for mixing the first material and the second material and dispensing a mixture of the first material and the second material.

### FIELD OF THE DISCLOSURE

Aspects of the present disclosure relate to an apparatus and system for filling joints, and methods of use thereof. More particularly, aspects of the present disclosure are related to an apparatus and system for filling joints, cracks, and/or surface irregularities in concrete or other hard surfaces.

### BACKGROUND

When floors, foundations, or walls are formed of cured material, such as concrete, expansion joints are provided to allow the cured material to expand and contract throughout the life of the product. It is generally desirable to fill expansion joints with a material that has a greater flexibility than the cured material to prevent water intrusion or intrusion and/or buildup of other contaminants, such as dirt while allowing for expansion and/or contraction of the cured material. In addition, filling expansion joints may also prevent damage to the cured material due to traffic or other occurrences that may damage the edges of the expansion joint. Expansion joints are also filled for aesthetic reasons. For example, a smooth uninterrupted concrete floor may be desired for aesthetic reasons. Joint fillers that are used in joints or between two or more portions of a cured material that are intended to move relative to one another may be referred to as semi-rigid joint fillers.

Further, cracks may form in cured materials during the curing process and/or as materials age. In such cases, structural fillers may be used to repair and/or prevent further progression of cracks. Such structural fillers may also for example be used to rebuild joint edges or broken slab panel corners to name a few examples. Structural joint fillers are commonly used to maintain concrete or other cured material surfaces as the cured material ages.

Both structural and semi-rigid joint fillers are frequently applied in two-parts that are mixed together. The two-parts may include a first material, which may comprise a isocyanate and is frequently referred to as “Part A” and a second material, which is frequently referred to as “Part B” and comprises a polyol. The two materials are combined which results in the hardening and/or setting of the structural and/or semi-rigid joint filler.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In one aspect of the disclosure, A joint filler system for transporting, mixing, and selectively dispensing a two-part joint filler material directly from a first commercial container containing a first material of the two-part joint filler and a second commercial container containing a second material of the two-part joint filler is disclosed. The system includes a first pump configured to provide a suction force for conveying the first material of the two-part joint filler material from the first commercial container to a joint filler wand. The system further includes a second pump configured to provide a suction force for conveying a second material of the two-part joint filler material from the second commercial container to the joint filler wand. The first pump and second pump are fluidly connected to the joint filler wand via a hose, and the first material and the second are conveyed to a distal end of the joint filler wand for mixing and dispensing a mixture of the first material and the second material.

In one aspect of the present disclosure, a method of using a joint filler apparatus for transporting, mixing, and selectively dispensing a two-part joint filler material directly from a first commercial container containing a first material of the two-part joint filler and a second commercial container containing a second material of the two-part joint filler is disclosed. The method includes supporting the first commercial container and the second container on the joint filler apparatus frame and using a first pump of the joint filler apparatus to provide a suction force for conveying the first material of the two-part joint filler material from the first commercial container to a joint filler wand. The method further includes using a second pump of the joint filler apparatus to provide a suction force for conveying a second material of the two-part joint filler material from the second commercial container to the joint filler wand of the joint filler apparatus, wherein the first pump and second pump are fluidly connected to the joint filler wand. The method also includes dispensing the first material and the second material from a distal end of the joint filler wand for mixing and applying a mixture of the first material and the second material.

In one aspect of the present disclosure, a joint filler apparatus for transporting, mixing, and selectively dispensing a two-part joint filler material is disclosed. The apparatus includes a first suction tube configured to have a distal end thereof submerged within the first container of the first material and a first pump configured to provide a suction force to the first suction tube for conveying the first material of the two-part joint filler material from the first container to a joint filler wand. The apparatus further includes a second suction tube configured to have a distal end thereof submerged within the second container of the second material, and a second pump configured to provide a suction force to the second suction tube for conveying a second material of the two-part joint filler material from the second container to the joint filler wand. The first pump and second pump are fluidly connected to the joint filler wand via a hose and the first material and the second are conveyed to a distal end of the joint filler wand for mixing the first material and the second material and dispensing a mixture of the first material and the second material.

Additional advantages and novel features of these aspects will be set forth in part in the description that follows, and in part will become more apparent to those skilled in the art upon examination of the following or upon learning by practice of the present disclosure.

### BRIEF DESCRIPTION OF THE DRAWINGS

The novel features believed to be characteristic of aspects of the present disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The present disclosure itself, however, as well as a preferred mode of use, further objects and advantages thereof, will be best understood by reference to the following detailed description of illustrative aspects of the disclosure when read in conjunction with the accompanying drawings, wherein:

FIGS. 1A illustrates a front view of example joint filling system in accordance with according to aspects of the present disclosure.

FIG. 1B shows a partial cut-away view to show example aspects of the joint filling system shown in FIG. 1A.

FIG. 2A illustrates a rear view of the example joint filling system of FIGS. 1A-1B according to aspects of the present disclosure.

FIG. 2B illustrates a partial magnified view to show example aspects of the joint filling system show in FIGS. 1A-2A.

FIG. 3 illustrates a side view of the example joint filling system of FIGS. 1A-2B according to aspects of the present disclosure.

FIG. 4A illustrates a right side view of a rear internal portion of the example joint filling system of FIGS. 1A-3 according to aspects of the disclosure.

FIG. 4B illustrates a left side view of a rear internal portion of the example joint filling system of FIGS. 1A-4A according to aspects of the disclosure.

FIG. 5A illustrates a partial front view of the example joint filling system of FIGS. 1A-4B with two-part joint filler containers placed thereon according to aspects of the disclosure.

FIG. 5B is a side view of a suction tube usable with the joint filing system according to aspects of the disclosure;

FIGS. 6A-6E show a filler dispensing wand, elongated mixing device, and example aspects thereof according to aspects of the disclosure.

FIG. 7 shows an example of clean-out tanks usable with aspects of the disclosure.

FIG. 8 shows an exploded view of a gear pump usable with joint filling systems according to aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

For context, a broad overview is provided of aspects of the present disclosure and the advantages the present disclosure provides. This overview, and the detailed description that follows, been presented for purposes of illustration and description. It is not intended to be exhaustive nor to limit the present disclosure to the forms described. Numerous modifications are possible in light of the above teachings, including a combination of the abovementioned aspects. Some of those modifications have been discussed and others will be understood by those skilled in the art. The various aspects were chosen and described in order to best illustrate the principles of the present disclosure and various aspects as are suited to the particular use contemplated. The scope of the present disclosure is, of course, not limited to the examples or aspects set forth herein, but can be employed in any number of applications and equivalent devices by those of ordinary skill in the art. Rather, it is hereby intended the scope be defined by the claims appended hereto.

Throughout the disclosure, the term substantially or approximately may be used as a modifier for a geometric relationship between elements or for the shape of an element or component. While the terms substantially or approximately are not limited to a specific variation and may cover any variation that is understood by one of ordinary skill in the art to be an acceptable variation, some examples are provided as follows. In one example, the terms substantially or approximately may include a variation of less than 10% of the dimension of the object or component. In another example, the terms substantially or approximately may include a variation of less than 5% of the object or component. If the terms substantially or approximately are used to define the angular relationship of one element to another element, one non-limiting example of the terms may include a variation of 5 degrees or less. These examples are not intended to be limiting and may be increased or decreased based on the understanding of acceptable limits to one of ordinary skill in the art.

For purposes of the disclosure, directional terms are expressed generally with relation to a standard frame of reference when the system and apparatus described herein is installed and in an in-use orientation.

In order to provide context to the current disclosure, a broad overview of an example implementation of the system and apparatus in accordance with the current disclosure and the advantages provided by the disclosure are described below. Further details of example implementations of the current disclosure are described in detail below.

As mentioned above, both structural and semi-rigid joint fillers are frequently supplied to the user as two-parts (e.g., Part A and Part B) that are mixed together causing the joint filler to cure. Aspects of the current disclosure are related to method and a portable joint filler system that improves efficiency in transporting, mixing, and dispensing joint filler. In one preferred example, the first of the two-parts may comprise an isocyanate (e.g., Part A), and a second of the two-parts may comprise a polyol (e.g., Part B). The two materials are combined which results in the hardening and/or setting of the structural and/or semi-rigid joint filler. In another example, the two-parts may comprise a polyol as “Part A” and an isocyanate as “Part B.” Current aspects of the disclosure are related to efficient dispensing of structural and/or semi-rigid joint filler, which may hereinafter be interchangeably referred to as joint filler. One example system according to the current disclosure provides a portable system that allows for efficient and trouble-free dispensing and mixing of the aforementioned two-part joint filler. In one aspect, the disclosed system allows for dispensing and mixing of two-part joint filler directly from commercially available containers (e.g., 5 gallon drums of Part A and Part B), without requiring additional steps of transferring material from a first container to a second container and greatly reducing time, effort, and the quantity of chemicals required for clean-up and/or flushing of the system.

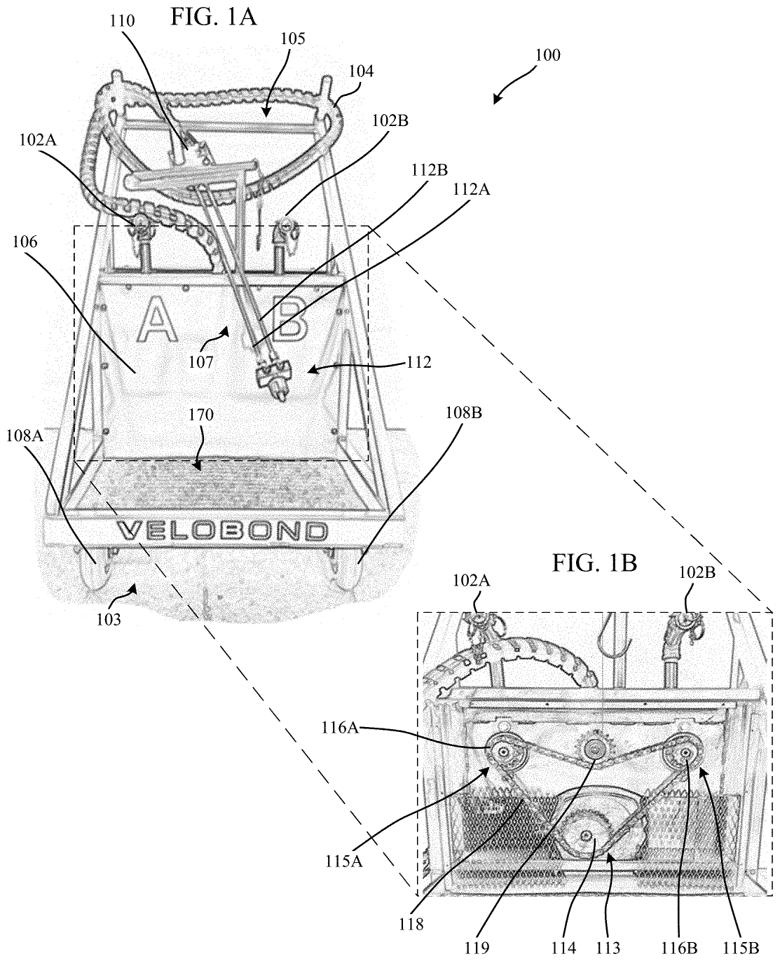

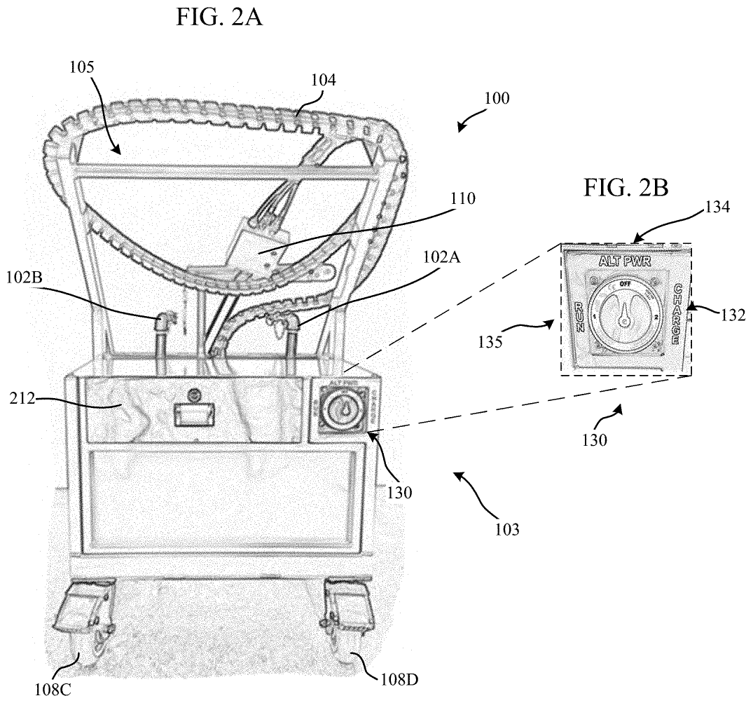

As shown in FIGS. 1A and 1B, a joint filler system 100 according to the current disclosure may include a joint filler system frame 103. The joint filler system frame may for example be comprised of any rigid material suitable for supporting the components of the system described below. In one example, the joint filler system frame may for example be comprised of a series of metallic tubes or square tube stock welded together to form a frame as shown in FIGS. 1A-3. The metallic tubes may comprise steel or aluminum to name a few non-limiting examples. As shown in FIG. 2A, in one example, the frame of the joint filler system 100 may have a locking drawer 212 for storage of items (e.g., power cords, mixing devices, or other accessories).

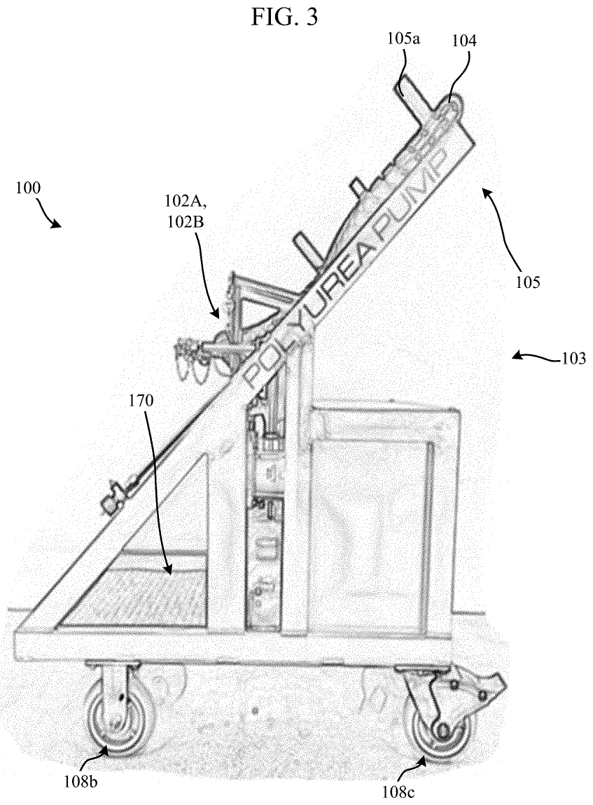

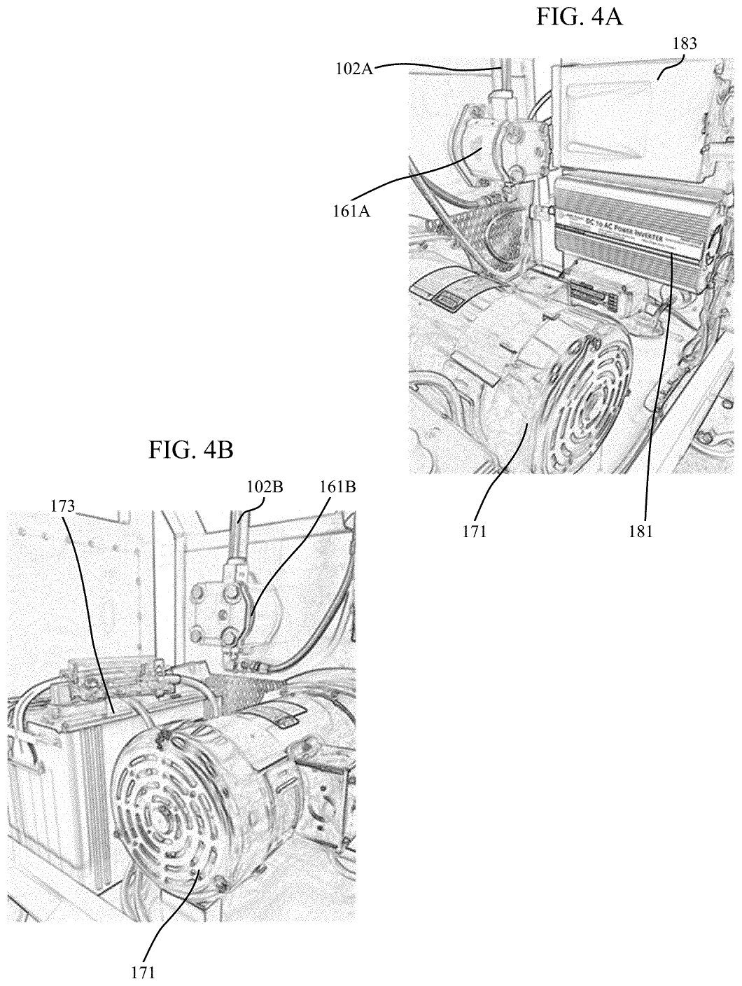

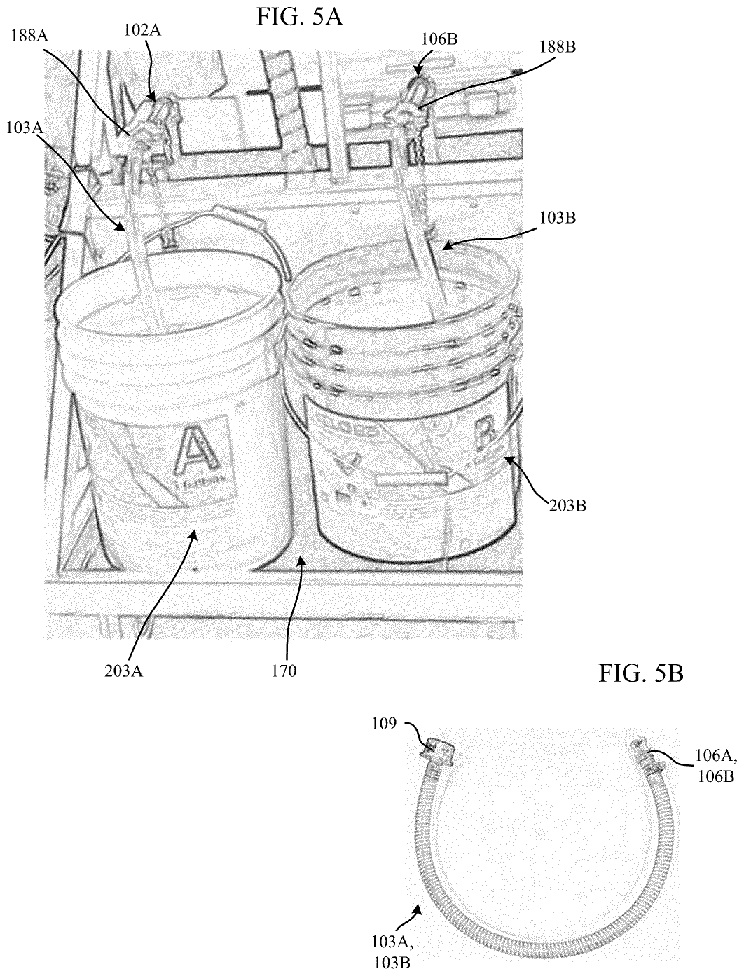

The joint filler system 100 may further include a joint filler container holding base 170 that may be a flat surface dimensioned to receive and/or have placed thereon commercially available containers of two-part joint filler (e.g., two 5 gallon drums as shown in FIG. 4A). The flat surface of the holding base 170 may for example have carpet and/or a rubberized mat or coating to further provide stability and/or prevent sliding of commercially available containers placed thereon. Turning to FIGS. 1A-3, the joint filler system frame may further have wheels 108A, 108B, 108C, and 108D to allow an operator to easily roll the system and containers of joint filler along a surface. In one example aspect, wheels 108C and 108D may be swivel casters allowing user to guide the joint filler system 100 along a desired path. The swivel casters 108C and 108D may also have foot brakes connected thereto allowing a user to press down on the foot brake and lock rotation of either one of or both of casters 108C and/or 108D. Wheels 108A and/or 108B may for example be fixed casters. It is noted that the aforementioned wheel configuration is merely an example preferred implementation, alternatives may be implemented without departing from the scope of this disclosure. For example, wheels 108A and/or 108B may be swivel casters and 108C and 108D may be fixed casters, to name one alternative example implementation. As shown in FIGS. 1A, 2A, and 3, the frame 103 may further include a handle 105 and hose holding portion 105a (FIG. 3) for supporting wand hose 104. The system 100 may further include a connection portion 102A and a second connection portion 102B. The first connection portion 102A and/or 102B may be have corresponding first and second connector devices 188A and 188B configured to have suction tubes connected thereto (e.g., suction tube 103A, 103B in FIG. 4A-B). In one aspect, the connection portion 102A and second connection portion 102B may have connectors configured provide a fluid connection between suction tube(s) 103A and 103B and a respective first fluid pump 161A and a second fluid pump 161B (hidden from view in FIGS. 1A-3, shown in FIGS. 4A and 4B). As shown in FIGS. 1A and 5A, the suction tubes 103A and/or 103B may be selectively removable for cleaning and/or storage.

As shown in FIGS. 5A-5B, when connectors 106A and/or 106B of the suction tube(s) 103A and/or 103B are connected to respective first connection device 108A of connection portion 102A and second connection device 188B of the second connection portion 102B of the joint filler system 100, a distal end of a first suction tube 103A with filter(s) 109 may be placed or submerged within the first liquid joint filler material (e.g., an isocyanate “Part A”) in first container 203A, and a distal end of a second suction tube 103B with filter(s) 109 may be placed or submerged within a second liquid joint filler (e.g., “Part B”) material in a second container 203B. As shown in FIG. 5A, once a first suction tube 103A is connected to the connection portion 102A and placed within a container 203A of a first liquid joint filler material (e.g., an isocyanate “Part A”) a fluid path is provided to allow suction provided by first fluid pump 161A to draw the first material into the joint filler mixing and application wand 107, which may hereinafter be referred to interchangeable as wand 107. Likewise, once a second suction tube 103B is connected to the second connection portion 102B and placed within a container 203B of a second liquid joint filler material (e.g., a polyol “Part B”) a fluid path is established to allow suction provided by second fluid pump 161B to draw the second material into the joint filler mixing and application wand 107. The aforementioned aspects allow for a user to simply submerge the suction tubes 103A and 103B in to conventional containers of two-part joint filler material and allows for the proper mixing and application of joint fillers without the need to transfer the two-part joint filler material into additional containers mounted high on a machine, which may for example reduce the occurrence of spilling and wasting of material, reduce the need to clean-up spilled materials. For example, prior joint filler systems require transfer of the joint filler material from supplied containers (e.g., 5 gallon drums or buckets) into specific built-in or removable containers mounted high on a machine that are designed specifically for the joint filler system. Transfer of the joint filler material (e.g., by pouring the material into joint filler system container) may result in spilling or waste of the material. Further, the aforementioned aspects may greatly reduce or simplify a clean-up of the joint filler system 100 by allowing a user to merely dispose of the two-part joint filler containers (e.g., containers 203A and 203B in FIG. 5A) once they are empty or a specific job is completed instead of having to clean out or thin the material as is typically required in joint filler machines that have specific built-in or removable containers required for use.

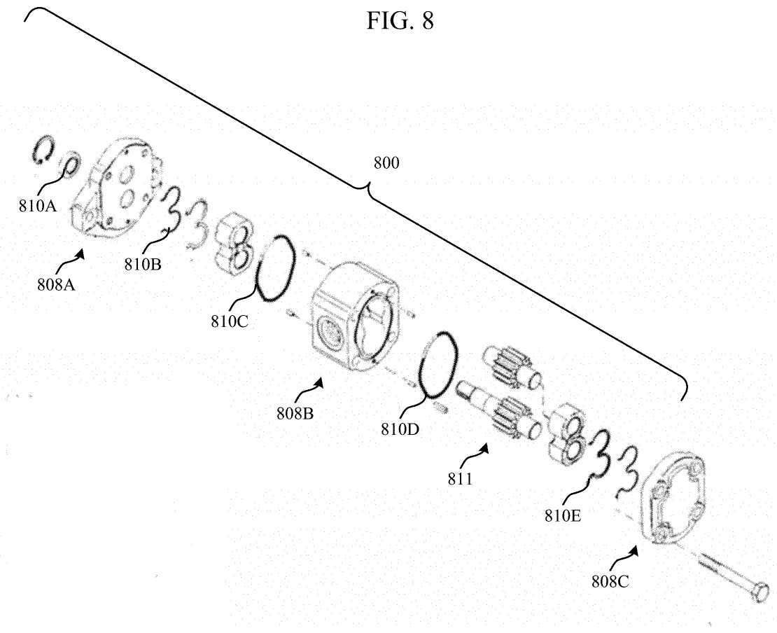

The first fluid pump 161A and second fluid pump 161B may for example be any type of known pump capable of pumping fluid, liquids, and/or oils. In one preferred example, the first pump 161A and the second pump 161B may for example be gear pumps that are driven a motor 171. One example of a pump usable with the current disclosure is described below with respect to FIG. 8.

Turning to FIG. 1B, the motor 171 (FIGS. 4A-4B) may for example provide rotational force to a driving element 113 (FIG. 1B). FIG. 1B shows a view of the joint filler device 100 with a cover panel 106 removed. In one example, the driving element 113 may be a driving sprocket 114 connected to the shaft of motor 171. The driving sprocket may be operatively connected to a first pump driving element 116A of a first pump 161A (FIG. 4A) and a second pump driving element 116B of the second pump 161B (FIG. 4B). As shown in FIG. 1B, the first pump driving element 116B and the second pump driving element 116B may be sprockets that are operatively connected to the driving sprocket 114 via a chain 118. In one aspect the first pump driving element 116A and the second pump driving element 116B may be sprockets that have the same number of teeth and thus spin at approximately the same rate when provided by a rotational force from the driving sprocket 114. In one aspect, the gear teeth of sprockets for the first pump driving element 116B and the second pump driving element 116B may differ if different ratios of a first material and/or second material are desired.

As shown in the example in FIG. 1B, a tensioner sprocket 119 may be provided to ensure proper tension on the chain 118 and/or to prevent the chain 118 from separating from the sprockets shown in FIG. 1B. It is noted that while a chain and sprocket configuration is shown in FIG. 1B, any system for transferring power to first pump 161A (FIG. 4B) second pump 161B (FIG. 4B) may be used. For example, a gear train, belt drive, and/or a direct drive connected to the first and second pumps 161A and/or 161B may be used without departing from the scope of the current disclosure. The motor may for example be powered via a battery (e.g., battery 173 in FIGS. 4A-4B) via a DC to AC inverter (e.g., inverter 181 in FIG. 4A) and/or may powered via an AC electrical source (e.g., a standard 110V or 220V outlet). In addition, the battery 173 may be re-chargeable via the aforementioned AC electrical source. As shown in FIG. 2B, the joint filler system may include a selector switch 130 for selection of a power source from a first source 129 (e.g., a battery 173), a second source 134 (e.g., an AC source), and/or for a charging mode 132 for charging the battery 173 via the AC source. The aforementioned aspects allow for the joint filler system 100 to be portable while still allowing the system to function via an AC source if desired or if the battery 173 needs to be recharged.

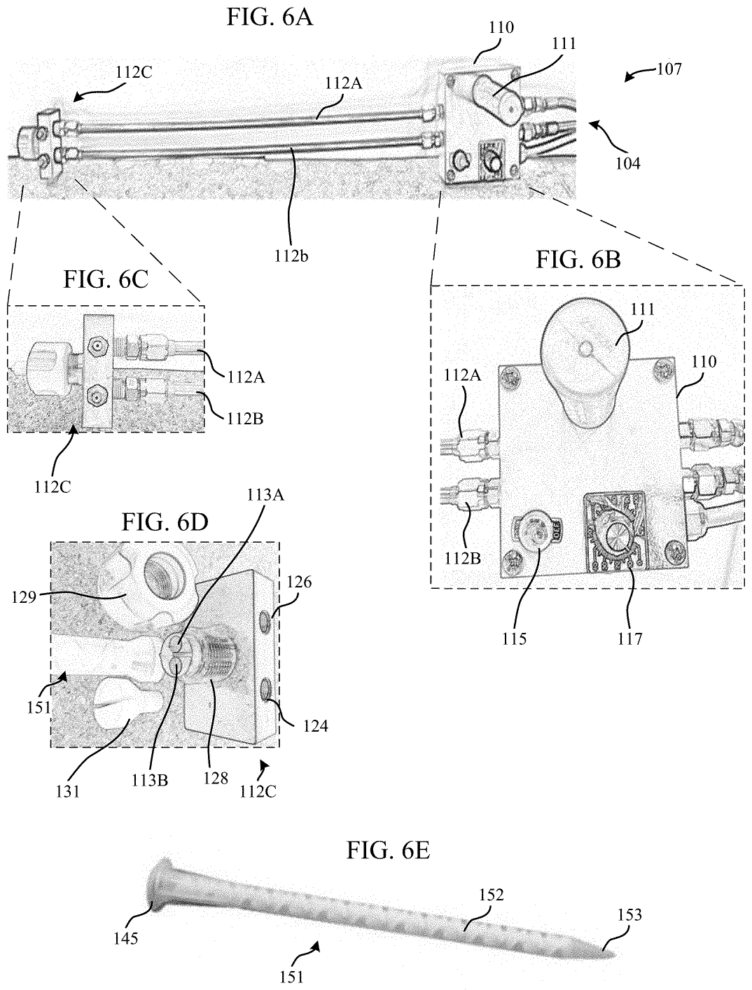

As mentioned above, the system 100 may further include an application wand 107. Turning to FIGS. 6A-6D, the application wand 107 may be in fluid communication with the first pump 161A and second pump 161B via wand hose(s) 104 that extend from the first pump 161A and the second pump 161B. In one example, the application wand 107 may include a regulator 110 and a first wand tube 112A and a second wand tube 112B connected to a mixer connection portion 112C. The regulator 110 may include a regulator adjustment portion 117 configured to control the rate at which the joint filler material (e.g., an isocyanate “Part A,” and polyol “Part B”) is supplied to the wand (and to the mixer connection portion 112C) by the first pump 161A and the second pump 161B by controlling the speed of motor 171. The wand 107 may include a wand handle 111 to allow a user to hold the wand and control application of the joint filler dispensed from an end of the wand 107. In addition, the application wand 107 may further include a supply switch 115 with an on position and an off position. In the on position, the motor 171 is controlled to rotate, and thus the first and second pumps 161A and 161B supply joint filler material to the wand 107. In the off position, the motor 171 is controlled to stop, and thus the first and second pumps 161A and 161B stop the supply of joint filler material to the wand 107. The regulator adjustment portion and/or the supply switch may be in signal communication with a motor controller (e.g., a potentiometer or other known motor controller) 183 (FIGS. 4A-4B) configured to control the speed of motor 171. In one aspect, the signal communication is provided by a cable that is bundled with the wand hose 104 and that connects the regulator 110 to the motor controller. However, it is noted that the aforementioned signal communication may also occur via wireless communication. Further while a separate supply switch 115 and regulator adjustment portion 117 is shown in the Figures, in one aspect these two functions may be combined (i.e., turning on or off the flow of joint filler material and controlling the rate of flow) may be controlled via a single pressure sensitive trigger mechanism or other mechanism. In one aspect, the trigger mechanism may comprise any known pressure sensitive trigger type mechanism known in the art.

FIG. 6C shows an assembled view of an example mixer connection portion 112C and FIGS. 6D and 6E show examples of a mixing device 151 and a partially disassembled view of the mixer connection portion. The mixer connection portion 112C may be connected and in fluid communication with the first and second wand tubes 112A and 112B. For example, the first wand tube 112A maybe in fluid communication with a first passage 113A and the second wand tube 112B may be in fluid communication with a second wand passage 113B. The first wand passage 113A and the second wand passage 113B may be configured align with and otherwise provide a fluid communication path with the internal chamber of mixing device 151. In one example, the mixing device 151 may be a commercially available mixing device that includes a partially hollow elongated chamber 152 that extends from a connector section to a tip portion 153. The mixing device 151 may include a number of interwinding passages, which may be referred to as mixing elements, within the chamber that cause two-part materials (e.g.,“Part A,” and “Part B”) to fully mix as they are supplied to the mixing device and exit as an activated product at tip 153. Since the curing process occurs as soon as the two-part joint filler material is mixed, it may be desirable to use a disposable mixing device since the joint filler may cure within the mixing device and result in clogging or decreased mixing performance. By providing a commercially available mixing device 151, a user may easily exchange the mixing device for a new mixing device if necessary.

The connector section 145 of the mixing device 151 may be secured over outlets 113A and 113B with retaining nut 129 to allow flow of material from the first passage 113A and the second passage 113B through the inner chamber 152 of the mixing element to mix the two-part joint filler material (e.g., “Part A,” and “Part B”) material supplied via the first wand tube 112A and the second wand tube 112B and thus active the curing of the joint filler. The connector section 145 of the mixing device 151, is connected to the mixer connection portion 112C via a threaded fastening portion 129 that is threaded onto a threaded receiving portion 128 of the mixer connection portion 112C. When the mixing device is supplied with a first joint filler material (e.g.,“Part A”) via first passage 113A and the second joint filler material (e.g., “Part B”) via the second passage 113B, the materials are mixed within the inner chamber 152 of the mixing device 151 to begin the curing process. The mixed joint filler is then supplied from a tip 153 of the mixing device 151 to allow the application of the joint filler as desired by a user. In one example aspect, the mixer connection portion 112C may further include a first grease port 126 and a second grease port for filling the mixer connection portion with grease when storing the device. Injection of grease into the grease ports 124 and 126 may help to provide an airtight seal within the device and/or prevent curing or setting of any chemicals that remain in the device after use. In one aspect, in order to prepare the device 100 for storage, the mixing device 151 may be removes, and a sealing device 131, which may be referred to as a night cap, may be secured over outlets 113A and 113B with the threaded fastening portion 129 to close off the ports to additionally help provide an airtight seal.

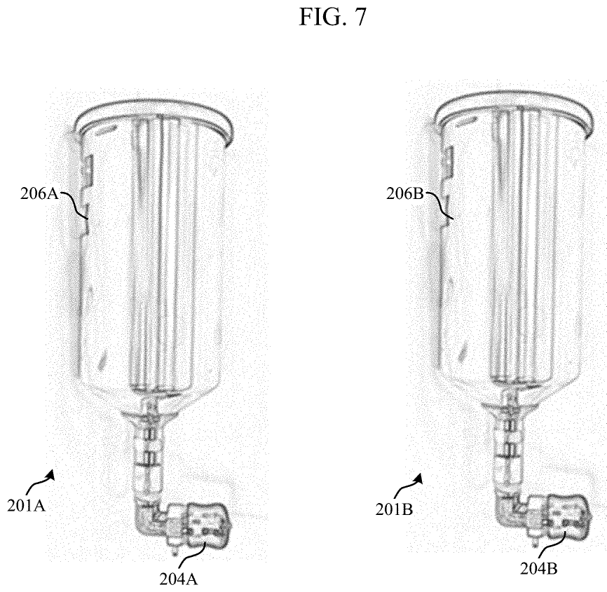

While one advantage of the a joint filler system 100 in accordance with the current disclosure is that joint filler material is less likely to cure within and/or otherwise clog the device, it may be desirable to clean the fluid passages of the device when switching materials and/or when storing the device long term. In one example, the system may further include a single or multiple flush tanks as shown in FIG. 7. For example, a first flush tank 201A may have a first flush tank connector 204A that is configured to connect to a first connector device 188A and thus create a fluid connection with connection portion 102A and a fluid contained or added to the tank portion 206A. A second flush tank 201B may have a second flush tank connector 204B that is configured to connect to the second connector device 188A and thus create a fluid connection with the second connection portion 102B and a fluid contained or added to the tank portion 206B of the second flush tank 201B. Once the flush tanks 201A and/or 201B are connected to the device. The device may be turned to force any fluid in the flush tanks through the device. In one example, the flush tanks 201A and/or 201B may be configured to contain xylene or a similar solvent for cleaning out the passages and/or pumps of the joint filler system 100. It is noted that the joint filler system may also be flushed via the joint filler suction tube(s) 103A and/or 103B, however providing flush tanks as described above may reduce the amount of xylene or similar solvent required to flush the system.

As mentioned above, the system may include a first and/or second pumps 161A and/or 161B. While not limited to the specific type of pump shown, one example of a pump usable with the disclosure is shown in FIG. 8. FIG. 8 shows an exploded view of a gear pump 200 with gears 810 for forcing a fluid therethrough (and thus providing a pressure difference when the pump 200 is rotated). The pump may include two outer housings 808A and 808C and a center housing 808B. In one preferred aspect of the disclosure, the seals within 810A-810E used to seal liquid within the pump may be formed of a material comprising any one or a combination of copolymers of hexafluoropropylene (HFP) and vinylidene fluoride (VDF or VF2), terpolymers of tetrafluoroethylene (TFE), vinylidene fluoride (VDF) and hexafluoropropylene (HFP) as well as perfluoromethylvinylether (PMVE) containing specialties. In one example, the seals 810A-810E may have a fluorine content between 66 and 70%. One example material that is preferred for use for the seals within 810A-810E is known under the trade name Viton™. The aforementioned seal construction may prevent the erosion of seals due to contact with chemicals used during the joint filling process and/or to clean or flush the joint filler system 100. For examples, the aforementioned seal construction prevents the degradation of seals due to contact with xylene and other solvents.

In one aspect the aforementioned aspects and components may be provided as a kit for partial assembly by a user. Further, the kit may include any one, a combination, and/or spare components to those discussed throughout the disclosure. In addition, the kit may include camlock caps or other caps or covering devices for covering any on or a combination of the aforementioned fluid connection portion(s).

Further, the aforementioned system and methods of filling joints and use of the joint filler system described in instructions provided with the joint filler system. The instructions may be provided as a pamphlet or as written instructions on the packaging of the system and/or as digital content (provided by accessing information on a network, such as a webpage on the Internet), for example. One example of instructions provided with the system may include any one or a combination of the instructions below. It is noted that while the directions below are numerically numbered, the order is not necessarily limiting or indicative of the order of operations in which the instructions or methods described in the instructions are to be completed.
1. Condition material to optimal pumping temperatures per manufacturer's recommendations. Typically 70° F. or above. This thins viscosity for ease of pumping.
2. Place isocyanate and polyol buckets on the proper sides of the front of the machine. Most manufacturers list the A side as isocyanate and the B side as polyol. Never cross these or risk potential curing within the lines, pumps and manifolds.
3. Disconnect camlock caps above the pumps and connect the suction hoses and place the filter ends into the buckets of material. (Always use the same hoses for each side).
4. Turn master switch (by drawer) to RUN, then turn on the handle power and adjust speed control (pot kit) to desired setting and dispense any fluids and grease until only clean joint filler is dispensed. Now add the mixer, dispense a small amount to ensure uniformity of color and cure and begin work.
5. When done, turn off power at handle and turn master switch to OFF so as not to drain battery life.
6. Remove hoses from the pipes above the pumps and immediately cap with cam lock caps to keep oxygenated air from contaminating the chemicals. It is recommended to grease these caps between longer periods of storage or overnight. Remove mixing nozzle, grease both sides of the manifold until grease exits, wipe excess grease on manifold threads, secure night cap with manifold nut.
8. Leave hoses within their partially filled buckets and secure lid tightly (best practice: add compressed nitrogen to the count of 3-5 before securing lids). Otherwise, clean hoses and connections and store separately in marked containers for each side.
9. Store pump until the next day or over the weekend (prolonged storage may require cleaning of the pump and lines with xylene (or similar solvent) then flush and store with oil. Cleaning is also required when changing products or colors.
10. Use separate containers for each side when cleaning with xylene or other solvents, and for oil flush.
11. Hose connections can be removed, cleaned and reused with the same hoses or use new reinforced hoses of the same size and specification if damaged.
12. Optional power: turn main switch to OFF, remove the power cord from the inverter and plug it into a generator or other direct power source.
13. To charge: turn the main switch to CHARGE and plug cord into a direct power source and into the charge receptacle on the side of the machine until battery is fully charged, about 4-6 hours.
14. Periodically lube the chain and tighten as necessary.
15. Pump replacement. Use the same pumps as listed below. Easily remove and replace pumps by disconnecting and connecting the 2 bolts. Be sure to contain fluids when disconnecting all plumbing lines.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the present disclosure. Therefore, the present disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

What is claimed is:

1. A joint filler system for transporting, mixing, and selectively dispensing a two-part joint filler material directly from a first commercial container containing a first material of the two-part joint filler and a second commercial container containing a second material of the two-part joint filler, the system comprising:
a first pump configured to provide a suction force for conveying the first material of the two-part joint filler material from the first commercial container to a joint filler wand;
a second pump configured to provide a suction force for conveying a second material of the two-part joint filler material from the second commercial container to the joint filler wand, wherein the first pump and second pump are fluidly connected to the joint filler wand via a hose, and wherein the first material and the second are conveyed to a distal end of the joint filler wand for mixing and dispensing a mixture of the first material and the second material.

2. The joint filler system of claim 1, wherein the distal end of the joint filler wand comprises connection portion configured to have connected thereto an elongated mixing device, wherein the elongated mixing device is configured to receive the first material and the second material from passages at the distal end of the joint filler wand and mix the first joint filler material with the second joint filler material before dispensing a mixture of the first joint filler material and the second joint filler material from a tip portion of the mixing device.

3. The joint filler system of claim 1, wherein the first pump and the second pump are gear pumps that are provided a rotational force via at least one motor.

4. The joint filler system of claim 3, wherein the joint filler wand further comprises a regulator portion, wherein operation of the regulator portion controls the speed at which the motor rotates.

5. The joint filler system of claim 4, wherein the joint filler wand further comprises a supply switch with a first position and a second position, wherein in the first position the joint filler system is configured to supply the first material and the second material to the joint filler wand and wherein in the second position the system is configured to stop supply of the first material and the second material to the joint filler wand.

6. The joint filler system of claim 1, wherein the joint filler wand further comprises a regulator portion, wherein operation of the regulator portion controls the rate at which the first material and the second material are supplied from the distal end of the joint filler wand.

7. The joint filler system of claim 1, wherein the joint filler system further comprise a battery for providing power to the first pump and the second pump.

8. The joint filler system of claim 7, wherein the suction force provided by the first pump and the second pump is provided by a single motor.

9. The joint filler system of claim 1, wherein the system further comprises a first suction tube and a second suction tube, wherein the first suction tube is configured to convey the first material to the first pump when a distal end of the first suction tube is submerged within the first material and wherein the second suction tube is configured to convey the second material to the second pump when a distal end of the second suction tube is submerged within the second material.

10. A method of using a joint filler apparatus for transporting, mixing, and selectively dispensing a two-part joint filler material directly from a first commercial container containing a first material of the two-part joint filler and a second commercial container containing a second material of the two-part joint filler, the method comprising:
supporting the first commercial container and the second container on the joint filler apparatus frame;
using a first pump of the joint filler apparatus to provide a suction force for conveying the first material of the two-part joint filler material from the first commercial container to a joint filler wand;
using a second pump of the joint filler apparatus to provide a suction force for conveying a second material of the two-part joint filler material from the second commercial container to the joint filler wand of the joint filler apparatus, wherein the first pump and second pump are fluidly connected to the joint filler wand; and
dispensing the first material and the second material from a distal end of the joint filler wand for mixing and applying a mixture of the first material and the second material.

11. The method of claim 10, wherein the distal end of the joint filler wand comprises connection portion configured to have connected thereto an elongated mixing device, wherein the method further comprises connecting an elongated mixing device configured to receive the first material and the second material from passages at the distal end of the joint filler wand and mix the first joint filler material with the second joint filler material before dispensing a mixture of the first joint filler material and the second joint filler material from a tip portion of the mixing device.

12. The method of claim 11, wherein the first pump and the second pump are operatively connected to a motor and the joint filler wand further comprises a regulator portion configured to control a speed of the motor, wherein the method further comprising operating the regulator portion to control the speed at which the motor rotates and control the rate at which the first material and the second material are dispensed.

13. The method of claim 10, further comprising:
submerging a first suction tube of the joint filler apparatus in the first material contained within the first commercial container to provide a supply of the first material to the first pump;
submerging a second suction tube of the joint filler apparatus in the second material contained within the second commercial container to provide a supply of the second material to the second pump.

14. A joint filler apparatus for transporting, mixing, and selectively dispensing a two-part joint filler material container containing a first material of the two-part joint filler and a second container containing a second material of the two-part joint filler, the apparatus comprising:
a first suction tube configured to have a distal end thereof submerged within the first container of the first material;
a first pump configured to provide a suction force to the first suction tube for conveying the first material of the two-part joint filler material from the first container to a joint filler wand;
a second suction tube configured to have a distal end thereof submerged within the second container of the second material; and
a second pump configured to provide a suction force to the second suction tube for conveying the second material of the two-part joint filler material from the second container to the joint filler wand, wherein the first pump and second pump are fluidly connected to the joint filler wand via a hose, and wherein the first material and the second are conveyed to a distal end of the joint filler wand for mixing the first material and the second material and dispensing a mixture of the first material and the second material.

15. The joint filler apparatus of claim 14, wherein the distal end of the joint filler wand comprises connection portion configured to have connected thereto an elongated mixing device, wherein the elongated mixing device is configured to receive the first material and the second material from passages at the distal end of the joint filler wand and mix the first joint filler material with the second joint filler material before dispensing a mixture of the first joint filler material and the second joint filler material from a tip portion of the mixing device.

16. The joint filler apparatus of claim 15, wherein the first pump and the second pump are gear pumps that are provided a rotational force via at least one motor.

17. The joint filler apparatus of claim 16, wherein the joint filler wand further comprises a regulator portion, wherein operation of the regulator portion controls the speed at which the motor rotates.

18. The joint filler apparatus of claim 17, wherein the joint filler wand further comprises a supply switch with a first position and a second position, wherein in the first position the joint filler apparatus is configured to supply the first material and the second material to the joint filler wand and wherein in the second position the system is configured to stop supply of the first material and the second material to the joint filler wand.

19. The joint filler apparatus of claim 17, wherein the joint filler wand further comprises a regulator portion, wherein operation of the regulator portion controls the rate at which the first material and the second material are supplied from the distal end of the joint filler wand.

20. The joint filler apparatus of claim 14, wherein the joint filler system further comprises a battery for providing power to the first pump and the second pump.
